(19) United States
(12) Patent Application Publication
(10) Pub. No.: US 2004/0055492 A1
(43) Pub. Date: Mar. 25, 2004

(54) Irreversible application of an invisible marking to polymer mouldings

(76) Inventors: Wihelmus H.H.A. Van Den Elshout, SIittard (NL); Saskia Van Dijk, Maastricht (NL); Esther Wessels, Emmen (NL)

Correspondence Address: Pillsbury Winthrop, Intellectual Property Group, 1600 Tysons Boulevard, McLean, VA, 22102, US

(21) Appl. No.: 10/332,276

(22) PCT Filed: Jul. 9, 2001
(86) PCT No.: PCT/NL01/00524

(30) Foreign Application Priority Data
Jul. 12, 2000 (NL) 1015686

(51) Int. Cl. B41F 31/00

(52) U.S. Cl. 101/491

(57) ABSTRACT

The invention relates to a process for the irreversible application of a marking invisible to the naked eye to a polymer moulding with the aid of laser radiation. The invention also relates to polymer compositions suitable for this purpose and to invisibly markable and marked mouldings that are entirely or partly made of the polymer composition. Invisible markings are for example useful for security purposes, for example to prevent unauthorized copying.

The moulding is entirely or partly made of a polymer composition containing a polymer and a compound (I), which compound through laser radiation can be irreversibly converted into a compound (II) that yields a visible contrast in the polymer composition only when irradiated with electromagnetic radiation at a wavelength outside the visible range of 400 to 700 nm.

The invention relates to a process for the irreversible application of a marking invisible to the naked eye to a polymer moulding with the aid of laser irradiation. The invention also relates to polymer compositions suitable for that purpose and to invisibly markable and marked mouldings made entirely or partly of the polymer composition. An invisible marking is useful for, for example, security purposes, for example to prevent unauthorized copying.

A similar process is known from FR 2755902 A1. This publication describes that a marking invisible to the eye can be applied to a polypropylene film using a laser so that, by choosing specific laser parameters, in particular the power, a change in the structure of the polymer material is obtained in the outer atom layers resulting in a marking invisible to the naked eye, but which becomes visible on being irradiated with suitably chosen electromagnetic radiation.

Within the context of the present application a marking invisible to the naked eye is understood to be a marking of such low contrast with its background, that a normal person will not see it without specific means under conditions of illumination with daylight or a similar light source, that is electromagnetic radiation of wavelengths essentially within the visible range of 400 to 700 nm.

The disadvantage of the aforementioned process is that it does not work for all polymer compositions. Only polypropylene is described in FR 2755902 A1 as an example. Where it does work at all, this process is moreover very laborious, because for each polymer composition one needs to determine the laser settings that will produce an invisible marking, and because in addition suitable electromagnetic radiation must be sought so as to reveal the marking. The required lasers, of which a large number of settings, such as the energy and wavelength, may be varied are very specialist and very expensive.

The aim of the invention is to provide a process that does not possess the aforementioned drawbacks, or possesses them to a lesser extent.

This aim is achieved with a moulding being entirely or partly made of a polymer composition containing a polymer and a compound (I), which compound can be irreversibly converted through laser radiation into a compound (II) that yields a visible contrast in the polymer composition only when irradiated with electromagnetic radiation at a wavelength outside the visible range of 400 to 700 nm.

It has been found that the process according to the invention enables invisible markings to be applied in a predictable and reproducible manner, irrespective of the type of polymer material chosen. Another advantage is that by choosing an appropriate compound (I), whether or not in combination with auxiliary materials, the markings may be applied with the aid of the customary cheaper lasers, for example with the aid of a 1064 or 532 Nd/YAg laser. Another advantage is that the polymer itself is not changed, which means that it is easier to make the markings invisible. Further, potential negative effects of local degradation of the polymer, e.g. (microscopic) foaming or changing of chemical resistance, are avoided. An indirect effect of local degradation with the known technique may be that markings become visible during use of the moulding; also this problem is diminished with the process according to the invention. The markings are also more wear-resistant. Another advantage is that, as will be described in more detail below, the process allows a larger number of different embodiments via the choice of compound (I), whether or not in combination with other additives such as colorants.

WO 9831018 A1 describes a process for the application, with the aid of laser radiation, of a fluorescent marking to a moulding, in particular a reversibly writable optical memory. In this process, a coating consisting of a markable polymer composition is applied from a solution to a moulding, after which the moulding is marked with the aid of a laser. The polymer composition contains a specific polyester in combination with a specific additive on which fluorescent markings can be made with the aid of a laser. The markings are reversible, which means that they gradually disappear on exposure to sunlight, and that they can be entirely deleted through heating above the polyester's glass transition temperature.

U.S. Pat. No. 4,871,714 A discloses a process for the application of a marking to a moulding which, for security purposes, is irreversible and invisible to the naked eye. In this process, an invisible UV fluorescent coating is affixed to a moulding as a security marking by means of a thermal transfer technique.

The principal drawback of the aforementioned known processes is that applying a coating to a preformed moulding is exceptionally laborious and expensive. The coating is not wear-resistant, which means that this coating and the marking applied in it will, at least without further measures, easily be damaged during use. Another major drawback is that the surface properties and the mechanical properties of the moulding are influenced by the coating. Another drawback is that the marking can in effect only be easily applied in areas where a coating can also be easily applied, preferably on a flat surface. Because of these drawbacks, these processes are actually used only in data storage devices. The known processes are not suitable for complexly shaped utilitarian objects, such as in particular three-dimensionally shaped mouldings of the kind obtained with various moulding techniques such as injection-moulding, compression-moulding, extrusion-moulding, blow-moulding, etc. In the process according to the invention the moulding is at least partly formed from the markable polymer composition, after which the marking can be immediately applied to any location on the moulding with the aid of a laser, without any further pre- or after-treatment. The marking is applied in the moulding material and not on top of the surface, which means that it is wear-resistant and the surface properties and mechanical properties of the moulding have not changed.

In one embodiment of the process according to the invention compounds I and II are both invisible to the naked eye. The advantage of this process is that it can be applied in any polymer, and in particular also in transparent applications such as films, bottles, synthetic glass, etc.

In another embodiment according to the invention compound(s) I and/or II are visible to the naked eye, but it is impossible to distinguish between them. An example of this is a coloured compound I that is by laser radiation converted into a compound II, which is of the same colour in visible light, or of a hardly contrasting colour; and can hence not be distinguished from compound I, but which when irradiated by non-visible light differs in colour from compound I and thus yields a contrast, for example as a result of metamerism or luminescence.

In yet another embodiment, compounds I and II are distinguishable to the naked eye per se, but they are not distinguishable to the naked eye in the polymer composition. This is for example possible because the polymer composition contains a pigment or colorant that masks the difference in the polymer composition in visible light.

The markings invisible to the naked eye may be made visible through irradiation with electromagnetic radiation at a wavelength outside the visible range from 400 to 700 nm, hereinafter also called: detection lighting. Compounds I and II preferably show a visible contrast because they differ in their degree of luminescence in UV or IR light.

In another embodiment of the process according to the invention compound I luminesces and compound II does not luminesce, or luminesces to a lesser extent. In this process the luminescent compound I is destroyed by the laser light, as a result of which it no longer luminesces and detection reveals a dark marking on a light luminescent background. The advantage of this embodiment is that more compounds I are available for use in this process.

In a more preferable embodiment according to the invention compound II luminesces and compound I does not luminesce, or luminesces to a lesser extent. In this embodiment detection lighting reveals a luminescent light marking on a dark background. The advantage of this is that the marking has a better contrast. Another advantage is that the object does not luminesce completely in the case of random or unintentional detection lighting. This is advantageous in circumstances in which detection light occurs for other reasons. This may also be particularly advantageous in the case of security codes because it is then more difficult to establish whether the object is secured with invisible codes.

The invention also relates to a polymer composition that is suitable for use in the aforementioned process, the composition containing a polymer and a compound (I), which compound through laser radiation can be irreversibly converted into a compound (II) that yields a visible contrast in the polymer composition only when irradiated with electromagnetic radiation at a wavelength outside the visible range of 400 to 700 nm.

Compound (I) in the polymer composition according to the invention preferably has a 1,2-substituted alkane bond, which is in a 1,2 elimination reaction with the aid of laser radiation converted into a luminescent alkene compound (II). As described above, the advantage of this is that the marking will then luminesce only under detection lighting. Another major advantage is that such compounds are thermostable and may nevertheless be converted with the aid of laser light, which makes them extremely suitable for polymer compositions that are moulded at high temperatures, for example by means of injection-moulding.

In another preferred embodiment compound (I) in the polymer composition according to the invention is a polycyclic aromatic compound. Such a compound shows luminescence, when radiated with UV light and can be converted into a non-luminescent compound (II) with the aid of laser light. Compound I is preferably derived from compounds chosen from the group comprising anthracene, phenanthrene, chrysene, pyrene, fluoroanthene, stilbene, benzanthracene or diphenylpolyene. ‘Derived’ is understood to mean that these molecules may have been substituted.

The polymer composition is in particular intended for use as a builder in the production of polymer mouldings. The mouldings may be produced in different ways, usually at elevated temperature, for example by means of extrusion, by blow-moulding, compression-moulding, injection-moulding, etc. Compound I is therefore preferably thermostable at least up to approximately the processing temperature of the polymer composition. Preferably, the moulding is formed from a melt of the polymer composition, preferably by means of injection-moulding, and the polymer in the polymer composition is a thermoplastic and compound I is thermostable at least up to approximately the melting temperature of the polymer composition. More preferably compound I is thermostable at least up the melt processing temperature of the polymer composition, which generally is some 20-40 degrees centrigrade above the melting temperature of the polymer.

The invention also relates to the use of the polymer composition according to the invention for the production of injection-mouldings and to a markable moulding entirely or partly made of a polymer composition according to the invention.

An invisible marking may be applied to the markable mouldings with the aid of a laser. The laser settings are geared to the properties of compound I, whether or not in combination with additives that promote the conversion of compound I into compound II, such as leucodyes, (laser) light-absorbing substances and the like. The great advantage of the process according to the invention is that commercially available and relatively cheap lasers may be used, such as a 1024 nm Nd/YAg laser, more or less irrespective of the type of polymer used in the polymer composition. The marked mouldings contain a polymer composition as described above and a marking containing compound II.

The polymer composition according to the invention is particularly advantageous for use in security applications, for example to prevent unauthorized copying or theft. Another useful application is a moulding according to the invention to which has been applied an invisible marking containing product and/or producer information. This information may be used in various ways, for example for quality assurance, for product liability or for recycling. A waste stream may for example be purified by identifying marked mouldings according to the invention, based on the code applied to them, and then selectively removing from the waste stream.

In another useful application of the markable moulding according to the invention, the moulding contains process instructions, for example relating to further installation, assembly and/or distribution. Examples of process instructions are connection diagrams for electronic components, logistic information, specific customer information and the like.

The invention also relates to a production process, wherein product requirements are entered in a computer, on the basis of which a laser subsequently writes process instructions on a moulding, after which the moulding is treated further according to these process instructions, for example in a device fitted with equipment for automatically reading and interpreting the marking and carrying out the process instructions. As it is not desirable for the process instructions to be visible during the object's final use, use is preferably made of an invisibly marked moulding according to the invention. In this way the production process is no longer controlled centrally, but by the process instructions on one or more parts of the product to be formed in that production process. This makes the production process very flexible. In this way, it is easier to allow for individual preferences of customers. Customers may thus communicate their individual preferences, for example via the Internet, which preferences are then computer-translated into process instructions and invisibly laser-marked on a polymer moulding, after which the further production takes place in accordance with the wishes specified by the customers in the user's instructions.

The invention will be further elucidated by the following example.

### EXAMPLE I

To PBT (polybutadiene terephthalate) Arnite® T06 200 was added the blue pigment Ultramarijnblauw 26 (Reckitt) and transstilbene. This composition was melt-mixed to form a homogeneous polymer composition, which was subsequently compression-moulded to form a test plate. A marking was then applied to the test plate using a 355 nm diode-pumped Nd/YaG laser (power 50 mW, 3 kHz, 100% amperage, in focus, writing speed 182 mm/sec, approx. 300 dpi). No marking was visible on the test plate with the naked eye. In UV light of 366 nm the marking became visible as a non-luminescent shape on a luminescent ground.

1. Process for the irreversible application of a marking invisible to the naked eye to a polymer moulding with the aid of laser radiation, characterised in that the moulding is entirely or partly made of a polymer composition containing a polymer and a compound (I), which compound through laser radiation can be irreversibly converted into a compound (II) that yields a visible contrast in the polymer composition only when irradiated with electromagnetic radiation at a wavelength outside the visible range of 400 to 700 nm.

2. Process according to claim 1, wherein compounds I and II are both invisible to the naked eye.

3. Process according to claim 1, wherein compound(s) I and/or II is/are visible to the naked eye but it is impossible to distinguish between the two.

4. Process according to claim 1, wherein compounds I and II are indistinguishable to the naked eye per se, but the polymer composition contains a pigment or colorant that makes the distinction invisible in the polymer composition.

5. Process according to any one of claims 1-4, wherein compounds I and II show a visible contrast because they differ in their degree of luminescence in UV or IR light.

6. Process according to claim 5, wherein compound I luminesces and compound II does not, or does to a lesser extent.

7. Process according to claim 5, wherein compound II luminesces and compound I does not, or does to a lesser extent.

8. Polymer composition suitable for use in a process according to claims 1-7, containing a polymer and a compound (I), which compound through laser radiation can be irreversibly converted into a compound (II) that yields a visible contrast in the polymer composition only when irradiated with electromagnetic radiation at a wavelength outside the visible range of 400 to 700 nm.

9. Polymer composition according to claim 8, wherein compound (I) has a 1,2-substituted alkane bond, which is in a 1,2 elimination reaction with the aid of laser radiation converted into a luminescent alkene compound (II).

10. Polymer composition according to claim 8, wherein compound I is a polycyclic aromatic compound.

11. Polymer composition according to claim 10, wherein compound I is derived from compounds chosen from the group comprising anthracene, phenanthrene, chrysene, pyrene, fluoroanthene, stilbene, benzanthracene or diphenylpolyene.

12. Polymer composition according to any one of claims 8-11, wherein compound I is thermostable at least up to approximately the processing temperature of the polymer composition.

13. Polymer composition according to claim 12, wherein the polymer in the polymer composition is a thermoplastic and compound I is thermostable at least up to approximately the melting temperature of the polymer composition.

14. Use of a polymer composition according to any one of claims 8-13 for the production of injection-mouldings.

15. Markable moulding entirely or partly made of a polymer composition according to any one of claims 8-13.

16. Marked mouldings containing a polymer composition according to any one of claims 8-13 and a marking containing compound II.

17. Marked mouldings according to claim 16, wherein the marking contains information about the moulding.

18. Marked mouldings according to claim 17, wherein the information contains process instructions.

19. Device for treating a marked moulding according to claim 17 or 18, characterised in that it is fitted with equipment for automatically reading and interpreting the process instructions and for treating the marked moulding according to these instructions.

20. Process for the production of articles in a multi-step process, wherein process instructions are laser-written on one or more components of the article, after which the instructions are automatically read in a subsequent process step and the process step is carried out according to these instructions.

21. Process according to claim 20, wherein the process instructions are generated in response to individual preferences of customers.

22. Process for purifying a waste stream, wherein marked mouldings according to any one of claims 16-18 are identified on the basis of the information applied to them and are selectively separated from the waste stream.
